(19) United States
(12) Patent Application Publication
(10) Pub. No.: US 2014/0184069 A1
(43) Pub. Date: Jul. 3, 2014

(54) DOOR-MOUNTED CABINET LAMP

(71) Applicant: JERRELL PENN HOLLAWAY, MELBOURNE, FL (US)

(72) Inventor: JERRELL PENN HOLLAWAY, MELBOURNE, FL (US)

(21) Appl. No.: 13/728,272

(22) Filed: Dec. 27, 2012

(51) Int. Cl. F21S 8/00; H05B 37/02

(52) U.S. Cl. CPC F21S 8/03; H05B 37/02
USPC 315/84; 362/249.01; 362/249.02; 362/133

(57) ABSTRACT

A battery powered LED lamp suitable for mounting on the inside surface of a cabinet door is described. The LEDs are arranged such that their light will illuminate the inside of the cabinet and its contents when the cabinet door is opened and left in a position roughly ninety degrees from its closed position. In a favorite embodiment, a photo sensor sends a signal to a microprocessor whenever the light level at the photo sensor is suddenly increased, which would likely happen whenever the door is opened. The microprocessor reacts to the signal by activating one or more LEDs for a prescribed period of time. Multiple LEDs are arranged in a pattern that will broadcast light into several shelves within the cabinet at the same time.

### BACKGROUND OF THE INVENTION

1. Field of the Invention

The Present invention relates to battery powered LED lamps.

2. Discussion of Related Art

There are currently many forms of small, inexpensive lamps that employ LEDs. Many of these products may be used around cabinets in the home. They usually serve to illuminate one particular spot in a cabinet, perhaps on a shelve, or under a cabinet. Another thing that most of these lamps have in common is a mechanical switch used to activate and de-activate the lamp. Some switches are placed to interface with a door. Others are manually operated. A few of these products use a photo sensor to recognize darkness and activate the lamp when the ambient light level is low.

The other common construction feature of currently available lamps is that the LEDs are always mounted perpendicular to the mounting surface of the lamp. This limits the direction that the LED light can be broadcast to a straight-ahead direction.

### SUMMARY OF THE INVENTION

The Door-mounted Cabinet Lamp has one or more LEDs placed in the same plane as the plane of the mounting surface. In a favorite embodiment, the lamp is disc shaped with a series of LEDs around the perimeter of the disc. When the lamp is attached to the inside surface of a cabinet door and the cabinet door is in the open position, the LEDs will broadcast light into the cabinet in a very helpful manner. The use of multiple LEDs, placed around the perimeter of the disc shaped lamp, provides light into the contents of several shelves at the same time.

In lieu of a mechanical switch, a photo sensor is used to detect a rapid change from dark to tight as the cabinet door is opened. The signal from the photo sensor is analyzed by a microprocessor so that a prescribed increase in ambient light within a prescribed time is sufficient to activate the LEDs. A timer within the program of the microprocessor controls the de-activation of the LEDs. In order to be activated again, the photo sensor must first see a decrease in ambient light, as would happen when the cabinet door is closed again.

### BRIEF DESCRIPTION OF THE DRAWINGS

FIG. 1 is a functional block diagram of the electrical components of a preferred embodiment.

FIG. 2 illustrates the physical arrangement of a preferred embodiment.

### DETAILED DESCRIPTION OF THE PREFERRED EMBODIMENTS

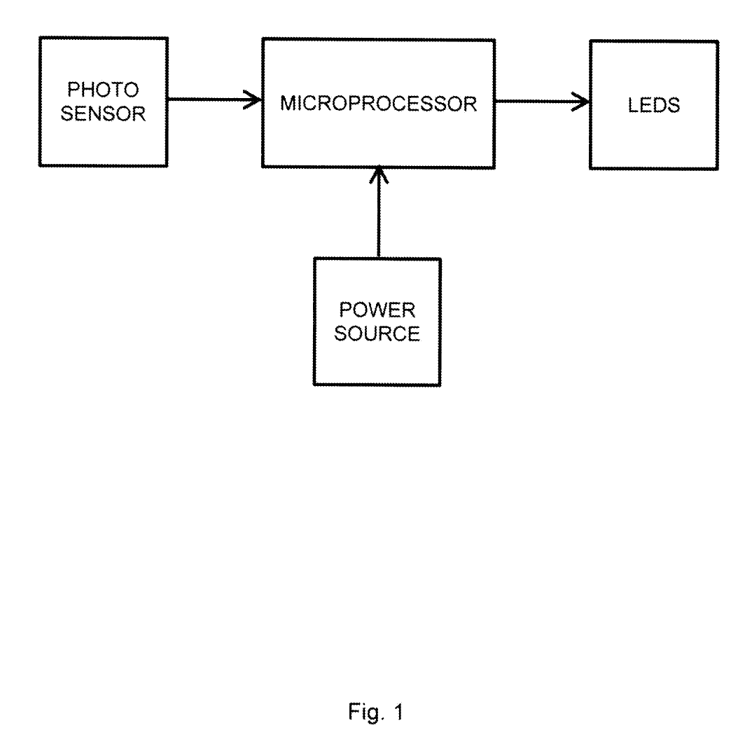

Referring to FIG. 1 the microprocessor is connected to a Power Source, a Photo Sensor, and one or more LEDs.

Starting with the Power Source, it can be any source of DC power suitable for operating the Microprocessor, Photo Sensor, and LEDs. In the simplest case, batteries are used.

The Photo Sensor sends a signal to the Microprocessor that represents the light level at the Photo Sensor. When the cabinet door is closed, the Photo Sensor sends a signal that represents relative darkness. When the door is opened, the signal represents a increased light level.

The Microprocessor does not react to prescribed light levels, but rather it reacts to a sudden increase in light level, which happens when the door is opened and the Photo Sensor is exposed to the ambient light in the room. U.S. Pat. No. 5,892,331, Hollaway, describes this unique method of operation and its application in a closet. The Hollaway patent also describes a timer function which de-activates the light bulb after a prescribed period of time. The Door-mounted Cabinet Lamp operates the same way as the Hollaway invention.

The Microprocessor is programmed to control power to one or more LEDs in response to signals from the Photo Sensor, so that each time the door is opened the LEDs are activated. The Microprocessor is also programmed to de-active the LEDs after a short period of time, perhaps in 15 seconds.

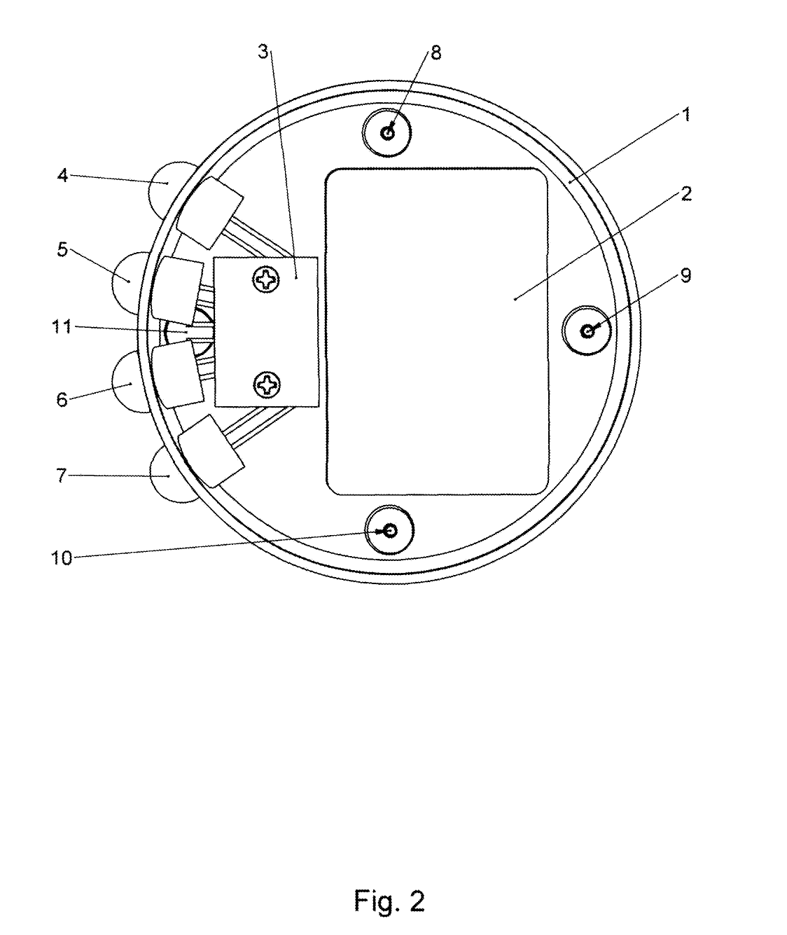

Referring now to FIG. 2, Enclosure 1 contains Battery 2, Circuit Board 3, and LEDs 4, 5, 6, and 7. The enclosure cover is not shown for simplicity LEDs 4, 5, 6, and 7 are connected to Circuit Board 3 and routed through the side of Enclosure 1 so that the light from the LEDs will broadcast in directions that are 90 degrees from the mounting surface of enclosure 1. Screw Holes 8, 9, and 10 may be used to mount the lamp to the inside of a cabinet door. LEDs 4, 5, 6, and 7 are spaced around the curved edge of enclosure I such that light is directed from top to bottom of multiple shelves within a cabinet.

Photo Sensor 11 is connected to Circuit Board 3 and positioned within an opening that senses ambient light outside Enclosure 1. When the cabinet door is closed Photo Sensor 11 will be in a relatively dark environment, but when the door is opened Photo Sensor 11 will view the ambient light outside the cabinet and activate LEDs 4, 5, 6, and 7.

Although a preferred embodiment has been described, there are many variations of the present invention that may be used. The Power Source, for example, may be 120 VAC household power. The Photo Sensor may be mounted in the Lamp in various locations, as long as an increase in light occurs at the Photo Sensor whenever the Door is opened. The LEDs can be arranged in many ways, or even replaced with other types of light producing elements, as long as light is broadcast into the cabinet when the door is in the open position.

I claim:

1. A lamp for illuminating the area inside of a cabinet comprising:
a. A power source,
b. An enclosure with a mounting surface,
c. Light producing elements supported by said enclosure such that the light from said elements is in a direction that is in the same plane as said mounting surface of said enclosure,
d. A circuit board to connect said power source to said elements.

2. The device in claim 1, wherein said light producing elements are LEDs.

3. The device in claim 1, wherein said circuit board includes a microprocessor and a photo sensor with said microprocessor programmed to activate said elements according to signals from said photo sensor.

4. The device in claim 3, wherein said microprocessor is programmed to cause said elements to be activated whenever said signals from said photo sensor indicate that there has been a sudden increase in light at said photo sensor.

5. The device in claim 4, wherein said microprocessor is programmed to cause said elements to be de-activated after a prescribed amount of time has passed.

6. A lamp suitable for mounting on the inside surface of a door.

7. The device in claim 6, wherein LEDs are arranged on said lamp to broadcast light into the area normally enclosed by said door if said door is in an open position.

8. The device in claim 7, wherein said LEDs are activated whenever said door is opened.

9. The device in claim 8, wherein said LEDs are activated by an increase in ambient light caused by the opening of said door.
